(19) United States
(12) Patent Application Publication
(10) Pub. No.: US 2012/0107533 A1
(43) Pub. Date: May 3, 2012

(54) COATED SUBSTRATE AND METHOD FOR THE PREPARATION THEREOF

(75) Inventors: Kjell Rune Andersson, Goteborg (SE); Erik Lindgren, Bohus (SE)

(73) Assignee: AKZO NOBEL CHEMICALS INTERNATIONAL B.V., Amersfoort (NL)

(21) Appl. No.: 13/379,206

(22) PCT Filed: Jun. 23, 2010
(86) PCT No.: PCT/EP2010/058861

§ 371 Date: Dec. 19, 2011

Related U.S. Application Data
(60) Provisional application No. 61/220,645, filed on Jun. 26, 2009.

(30) Foreign Application Priority Data
Jun. 26, 2009 (EP) 09163873.4
Dec. 22, 2009 (EP) 09180401.3

(51) Int. Cl. B05D 1/36; B41M 5/42; C08K 3/34

(52) U.S. Cl. 428/32.36; 524/493; 427/407.1; 427/411

(57) ABSTRACT

A method for the preparation of a coated substrate is provided, comprising the steps of providing a substrate; applying on at least one side of said substrate a first coating layer of a first aqueous composition comprising porous anionic pigment particles having a BET surface area of above 40 m2/g and a binder and applying on said first coating layer, a second coating layer of a second, aqueous composition comprising cationic colloidal silica or silicate based particles and polyalkylene glycol. It has been found that a substrate coated with the combination of the first coating layer and the second coating layer provides a suitable substrate for high-quality and fast-drying inkjet printouts.

### TECHNICAL FIELD OF THE INVENTION

The present invention relates to a method for the preparation of a coated substrate, as well as a coated substrate as such.

### TECHNICAL BACKGROUND

The development of inkjet printers has led to a demand for paper that is suitable for that purpose. Particularly, there is a demand for paper that is simple to produce but still enables inkjet printing of high quality.

It has been disclosed to use various kinds of coatings to produce paper suitable for inkjet printing. Examples of such coatings are disclosed in US Patent Application Publications 2002/0,039,639, 2002/0,164,464, 2003/0,099,816, 2003/0,224,129, 2004/0,255,820 and 2005/0,106,317, in U.S. Pat. No. 4,554,181, 5,551,975, 6,472,013 and 6,797,347, and in WO 03/011981, WO 01/53107, WO 01/45956, EP 947349, EP 1,120,281, EP 1,106,373 and EP 1,580,019. Other examples include U.S. Pat. No. 6,416,626, 5,352,503 and 6,110,601 disclosing coating compositions comprising silica, polyethylene glycol and an organic binder such as starch or polyvinyl alcohol.

A new generation of coating compositions based on silica or silicate is disclosed in WO 2006/049545, WO 2006/049546, WO 2006/049547 and WO 2008/105717. WO 2006/049545 discloses a coating composition comprising colloidal silica or aluminosilicate in combination with extender particles. WO 2006/049546 discloses a coating composition comprising silica or aluminosilicate in combination with a water soluble aluminium salt or a cationic polymer. WO 2006/049547 discloses a coating composition comprising colloidal silica or aluminosilicate in combination with a water soluble aluminium salt or a cationic polymer that can be used without any organic coating binder. WO 2008/105717 discloses a coating composition comprising colloidal silica or aluminosilicate in combination with a water soluble aluminium salt or a cationic polymer and a polyalkylene glycol.

### SUMMARY OF THE INVENTION

It is an object of the present invention to provide a method for the preparation of a coated substrate, especially such a coated substrate that is suitable for inkjet printing, which method is easy to perform. It is another object of the present invention to provide a coated substrate, especially such a coated substrate that is suitable for inkjet printing, which is easy to produce. It is yet another object of the present invention to provide a coated substrate that is suitable for inkjet printing and which enables high quality printouts.

It has been found that the above objects can be achieved by a novel combination of two coating compositions.

Thus, in a first aspect, the present invention relates to a method for the preparation of a coated substrate comprising the steps of: a) providing a substrate; b) applying, on at least one side of said substrate, a first coating layer of a first aqueous composition comprising porous anionic pigment particles having a BET surface area of above 40 m²/g and a binder; and c) applying, on said first coating layer, a second coating layer of a second aqueous composition comprising cationic colloidal silica or silicate based particles and polyalkylene glycol.

In a second aspect, the present invention relates to a coated substrate obtainable by the method of the invention.

In a third aspect, the present invention relates to a kit of parts including a first aqueous composition comprising porous anionic pigment particles having a BET surface area of above 40 m²/g and a binder, and a second aqueous composition comprising cationic colloidal silica or silicate based particles and polyalkylene glycol.

It has been found that a substrate coated with the combination of the first coating layer and the second coating layer on top of the first coating layer provides a suitable substrate for high-quality and fast-drying inkjet printouts. While the second layer is well adapted to retain and bind pigments and dyes in inks utilized in inkjet printers, while enabling a smooth surface with high gloss, the second layer is inferior in ink liquid absorption capacity. The first layer is superior in ink liquid absorption capacity, and can thus help absorption of the ink liquid into the surface. Hence, the present invention enables a coated substrate, suitable for inkjet printing with high gloss and rapid ink drying. Further, the method of the invention is relatively straight forward to implement in a production facility.

These and other aspects of the invention will now be described in the following detailed description of the invention.

It is to be noted that the present invention relates to all possible combinations of the appended claims.

### DETAILED DESCRIPTION OF THE INVENTION

The present invention relates to a coated substrate, especially substrates suitable for inkjet printing, and methods for the preparation of such coated substrates. The substrate is preferably a paper or paperboard web, but other substrates may also be contemplated, such as, but not limited to plastic films (such as for use in OH-films) and textile webs.

Paper and paper board to be coated can be made from any kind of pulp, such as chemical pulp like sulphate, sulphite and organosolve pulps, mechanical pulp like thermo-mechanical pulp (TMP), chemo-thermo-mechanical pulp (CTMP), refiner pulp or ground wood pulp, from both hardwood and softwood bleached or unbleached pulp that is based on virgin or recycled fibres or any combination thereof. Paper and paper board from any other kind of pulp may also be coated in accordance with the invention. The paper and paper board may be internally sized to various degrees or non-sized and may contain commonly used fillers such as various kinds of clay, calcium carbonate, talc etc. The paper may optionally be surface treated, such as with starch. The grammage may vary within a wide range, for example from about 40 to about 800 g/m² or higher, or from about 70 to about 300 g/m². In the following description the term paper refers to for both paper and paper board.

Typically, the coated substrate of the present invention is manufactured in a two-step coating process. In a first step, a first aqueous composition as defined herein is applied on at least one side of a substrate, such as a paper substrate, to form a first coating layer thereon. In a second step, a second aqueous composition as defined herein, being different from the first aqueous composition, is applied on top of the first coating layer, to form a second coating layer. It is preferred that no additional coating layer(s) is (are) arranged between the first coating layer and the second coating layer.

The first aqueous composition comprises porous anionic, preferably inorganic pigment particles having a BET surface area of above 40 m²/g, and a binder, and is typically applied to the substrate in form of an aqueous dispersion. The BET surface area of the composition is calculated as the weight average BET surface area of all pigment particles in the composition. The pigment particles having an average BET surface area of above 40 m²/g preferably comprises precipitated, fumed or gel-type silica or silicate based pigment particles. Preferably the inorganic pigment particles have a BET surface of from about 50, such as from about 70 to about 500, such as to about 400 m²/g.

As used herein, “BET surface area” refers to the surface area resulting from a measurement of N₂-absorption by the method described in Brunauer, S, Emmett, P. H., and Teller, E, “Adsorption of gases in Multimolecular Layers” J. Am. Chem. Soc., 1938, 60 (2), pp 309-319, and measurement by adsorption of N₂ at 177 K using a Micromeritics ASAP 2010 instrument

Preferably, the first aqueous composition comprises pigment particles having a BET pore volume of from about 0.15, such as from about 0.30, to about 1.5 such as to about 1.2 cm³/g. As used herein, “BET pore volume” refers to the pore volume from a measurement of N₂-absorption by the method described by Brunauer, S, Emmett, P. H, and Teller, E (supra).

The first composition may comprise other type of pigment particles in addition to or as alternatives to the above-mentioned silica or silicate based pigment particles. Examples of such pigment particles include, but are not limited to, kaolinites, smectites, talcites, calcium carbonate minerals, precipitated calcium carbonate, calcium sulphates and mixtures thereof. Preferably however, in the first composition, silica pigment particles may constitute from 50 to 100 wt % of the total amount of pigment particles.

Precipitated silica refers to silica formed when ultimate silica particles in an aqueous medium are coagulated as loose aggregates, recovered, washed, and dried. Precipitated silica is commercially available, for example under the trademarks Tixosil™, Zeolex™ 123, etc.

Gel-type silica refers to particles formed from a silica gel (usually described as a coherent, rigid three-dimensional network of contiguous particles of colloidal silica). Gel-type silica is commercially available, for example under the trademark Sylojet™. Fumed silica refers to silica prepared by a flame hydrolysis method. Fumed silica is commercially available, for example under the trademarks Cabosil™ and Aerosil™.

One or more binder is included in the first aqueous composition for the first composition to form, when dried, a coating layer on the substrate having suitable properties, such as layer integrity and adhesion to the base substrate. In embodiments of the present invention, the one or more binder comprises one or more organic binder. Examples of such organic binders include, but are not limited to, polyvinyl alcohols, optionally modified starches, gums, protein binders (e.g. caseins and soy protein binders), latices (e.g. based on styrene butadien, acrylates, vinyl acetate, co-polymers of ethylene and vinyl acetates, styrene acrylic esters etc.) and mixtures thereof. The binder may, for example, be present in an amount from about 5 pph (weight parts per hundred weight parts of pigments), such as from about 10, to about 50, such as to about 40 pph, for example in the range of 10 to 30 pph.

Further, the first composition may comprise rheology modifiers, such as cellulosics, for example carboxymethylcellulose (CMC). The amount of rheology modifiers in the first composition will depend on the viscosity desired, and may be in the range of from about 0, such as from about 0.5, to about 15, such as to about 10 pph (weight parts per hundred weight parts of pigments). The first composition is typically in form of a dispersion in water. The water and optional rheology modifier content of the composition is preferably tailored to obtain a composition having a suitable viscosity. This viscosity level desired is depending on the method of applying the composition to the substrate, as will be known to those skilled in the art, but will generally be in the range of from 100 cP to 2000 cP, as measured at 25° C. on a Brookfield viscosity meter equipped with a No 4 spindle, at 50 rpm.

The total content of pigment particles in the first aqueous composition is preferably from about 1 to about 70 wt % of the total composition, most preferably from about 5 to about 60 wt %, particularly most preferably from about 10 to about 60 wt % or from about 20 or even from about 25 to about 60 wt % of the total aqueous composition.

The first composition may further comprise other conventional components, normally used in paper coating compositions, such as, but not limited to, fluorescent whitening agents, colouring dyes, insolubilisers, lubricants, microbiocides, stabilisers, sizing agents, anti-foamers, etc.

The pigment particles of the first aqueous composition are preferably anionic. The preferred components of the first composition are naturally anionic and therefore, the preparation of this composition is conventional in the art.

The first aqueous composition is applied on the base substrate using any type of coating means known to those skilled in the art. The composition is typically applied on the substrate to form an essentially continuous coating layer on the entire substrate surface, even though it is also contemplated to arrange the coating on the substrate in a patterned fashion.

The first aqueous composition is preferably applied on the substrate in an amount sufficient to yield a first coating layer with a dry composition weight of from about 0.4 to about 40 g/m², more preferably from about 0.5 to about 40 g/m², most preferably from about 1 to about 25 g/m² per coated side of the substrate.

A second aqueous composition is to be applied on top of the first coating layer obtained from the first aqueous composition, to form a layered structure on the substrate. The second aqueous composition comprises cationic colloidal silica or silicate based particles, and does further comprise polyalkylene glycol. The polyalkylene glycol preferably constitutes from 50 to 100, such as from 60 to 100 or from 70 to 100 wt % of the total amount of organic material in the second aqueous composition. The polyalkylene glycol content in the second aqueous composition is preferably from about 2 pph (weight parts per hundred weight parts of dry silica or silicate based particles), such as from about 10, to about 60, such as to about 50, for example to about 40 pph based on 100 weight parts of dry silica or silicate based particles.

It has been found that the presence of polyalkylene glycol enables high concentration of particles, rendering it possible to apply high amounts of particles on paper or paperboard in a single coating operation. Further, excellent results can be obtained by coating paper or paperboard with a second aqueous composition comprising no or only low amounts of other organic materials, particularly organic binders. The second aqueous composition is thus preferably free from organic binders, or comprises, based on the total amount of pigment particles, less than 30, preferably less than 10, most preferably less than 3 or less than 1 wt % of organic binders. Examples of such organic binders include, but are not limited to, those mentioned above in connection to the first aqueous coating composition.

The term polyalkylene glycol as used herein refers to polymers of alkylene oxide, preferably being substantially free from other co-polymerised monomers. Preferred polyalkylene glycols are substantially free from substituents. Useful polyalkylene glycols include polyethylene glycol (PEG), polypropylene glycol and mixtures thereof, of which polyethylene glycol is particularly preferred. The average molecular weight M_{w} of the polyalkylene glycol is preferably from about 10,000, such as from about 20,000, to about 500,000, such as to about 300,000 D. A high molecular weight, such as above 100,000, for example above or about 200,000 D is advantageous in some cases as this allows calendering at higher temperatures, which in turn allows for products with higher gloss.

The second aqueous composition comprises cationic colloidal silica or silicate based particles that preferably are synthetic and amorphous. The combination of comparatively high amounts of cationic colloidal silica or silicate based particles with polyalkylene glycol has been found to give excellent printing properties of coated substrates, such as coated paper.

The cationic colloidal silica or silicate based particles preferably have a colloidal particle mean diameter from about 5 to 125 nm, such as from 10 to 100 nm. The cationic colloidal silica or silicate based particles in the second aqueous composition may be aggregated into porous aggregates preferably having a mean diameter of less than about 25 μm, more preferably less than about 15 μm. It is to be understood that the average diameter of such porous aggregates is always larger than the average diameter of the particles they are formed from. The term diameter as used herein refers to the equivalent spherical diameter. The surface area of the aggregates is usually essentially the same as of the cationic colloidal particles forming the aggregates. The cationic colloidal particles preferably have a surface area from about 30 to about 600 m²/g, more preferably from about 30 to about 450 m²/g, most preferably from about 40 to about 400 m²/g or from about 50 to about 300 m²/g, as measured according to the method described by G. W. Sears in J. Anal. Chem., 28, 1981.

The net surface charge of the colloidal silica or silicate based particles in the second composition is predominantly positive, in which case these particles are regarded as cationic.

The cationic nature of the silica or silicate based particles of the second aqueous composition may for example be achieved by using commercially available compositions comprising predominantly cationic silica or silicate based particles, such as a cationic silica sol, or by addition of cationic component(s) to an a composition comprising predominantly anionic silica or silicate based particles, such as an anionic silica sol.

As the cationic component the second composition preferably comprises a water soluble aluminium salt, a cationic organic polymer or a mixture thereof.

A water soluble aluminium salt is preferably present the second aqueous composition in an amount from about 0.1 to about 10 wt % most preferably from about 0.2 to about 5 wt %, calculated as wt % Al₂O₃ on the colloidal silica or silicate based particles. Any aluminium containing salt may be used and examples of salts include aluminium chloride, poly aluminium chloride, poly aluminium silicate sulphate, aluminium sulphate, and mixtures thereof. The aluminium may be present partly or fully on the surface of the colloidal silica or silicate based particles and optional other pigment particles or in the aqueous phase.

The entire content of water soluble aluminium salt in the second aqueous composition may originate from the cationic colloidal silica or silicate based particles. However, the pigment composition may also comprise additional water soluble aluminium salt.

A cationic organic polymer preferably has an average molecular weight M_{w} from about 2,000 to about 1,000,000 D, most preferably from about 2,000 to about 500,000 D, or from about 4,000 to about 200,000 D. The charge density is preferably from about 0.2 to about 12 meq/g, most preferably from about 0.3 to about 11 meq/g, or from about 0.5 to about 10 meq/g. The cationic organic polymer is preferably present in the second aqueous composition in an amount from about 0.1 to about 20 wt %, more preferably from about 0.3 to about 15 wt %, most preferably from about 0.4 to about 10 wt %, based on the amount of dry pigment particles. Examples of suitable cationic organic polymers include synthetic and natural polyelectrolytes such as PAM (polyacryl amides), polyDADMAC (poly diallyl dimethyl ammoniumchloride), polyallyl amines, polyamines, polysaccharides and mixtures thereof, preferably fulfilling the above specifications in respect of molecular weight and charge density. The cationic polymer may be present partly or fully on the surface of the colloidal silica or silicate based particles and optional other pigment particles or in the aqueous phase.

The entire content of cationic polymer in the second aqueous composition may originate from the cationic colloidal silica or silicate based particles. However, the pigment composition may also comprise additional cationic polymer.

Particularly preferred second aqueous compositions comprise one or both of a water soluble aluminium salt as described above and a cationic polymer as described above.

The dry content of the cationic silica or silicate bases particles in the second aqueous composition is preferably from about 0.5 to about 70 wt %, most preferably from about 1 to about 60 wt %

In an embodiment the cationic colloidal particles of the second composition comprise silica based particles. In another embodiment the cationic colloidal particles comprise silicate based particles, such as aluminosilicate or borosilicate. Examples of colloidal borosilicate particles and their preparation include those described in e.g. WO 99/16708. Mixtures of various kinds of cationic colloidal silica based and silicate based particles, or aggregates thereof, may also be used. The cationic colloidal silica or silicate based particles in the second aqueous composition preferably originates from a sol of colloidal silica or silicate based particles. The sol of colloidal silica or silicate based particles in the second aqueous composition have preferably been formed from an aqueous solution of alkali metal silicate where alkali metal ions are replaced by hydrogen ions. In order to obtain a low salt content sol, an ion exchange or a membrane process is preferably used. A process based on ion exchange follows the basic principles described in R. K. Iler, “The Chemistry of Silica” 1979, pages 333-334 and results in an aqueous sol comprising colloidal negatively or positively charged particles of silica or silicate based particles.

The second aqueous composition may comprise colloidal particles of silica that may or may not be core or surface modified, for example with a metal oxide or other metal salt such as oxide or other salt of aluminium, titanium, chromium, zirconium, boron or any other suitable metal.

Suitable aqueous sols of colloidal silica or silicate based particles are commercially available, for example under the trademarks Ludox™, Snowtex™, Bindzil®, Nyacol™, Vinnsil™ or Fennosil™.

Unlike a sol formed by dispersing a powder of e.g. precipitated silica, gel-type silica or fumed silica, the colloidal particles in a sol prepared from alkali metal silicate by ion exchange or membrane process have never been dried to a powder.

It has been found that sols prepared from alkali metal silicate by ion exchange, and particularly those having comparatively low surface area, give such a good adherence of the pigment particles to the underlying surface that the use of organic binders can be dispensed with.

Parts or all of the cationic colloidal silica or silicate based particles in the second aqueous composition may be in the form of aggregates. Aggregation of particles in a sol to form a dispersion of aggregates may be performed with any suitable method, such as those described in R. K. Iler, “The Chemistry of Silica” 1979, pages 364-407. The degree of aggregation can be followed by measuring the viscosity and applying the Einstein and Mooney equations (see e.g. R. K. Iler, “The Chemistry of Silica” 1979, pages 360-364). The aggregation may be performed as a separate step or in a mixture also comprising other pigment particles.

In one embodiment, an anionic sol (comprising negatively charged colloidal particles) and a cationic sol (comprising positively charged colloidal particles) are mixed, resulting in the formation of cationic aggregates of particles from both the sols.

In another embodiment a salt, preferably selected from divalent, multivalent or complex salts, is added to an anionic or cationic sol also resulting in the formation of cationic aggregates. Examples of salts are aluminium chloride, poly aluminium chloride, poly aluminium silicate sulfate, aluminium sulfate, zirconium carbonates, zirconium acetates, alkali metal borates, and mixtures thereof.

In still another embodiment a bridging substance is used to form the aggregates from the primary particles. Examples of suitable bridging substances are synthetic and natural polyelectrolytes such as CMC (carboxymethyl cellulose), PAM (polyacryl amides), polyDADMAC (poly diallyl dimethyl ammoniumchloride), polyallyl amines, polyamines, starch, guar gums, and mixtures thereof.

Any combination including one, two or all three of the above aggregation methods can also be employed.

The second aqueous composition may additionally comprise particles of one or more of other inorganic materials such as particles of kaolinites, smectites, talcites, calcium carbonate minerals, precipitated calcium carbonate, calcium sulphates, precipitated silica, gel-type silica, fumed silica and mixtures thereof.

The content of cationic colloidal silica or silicate based particles in the second aqueous composition is preferably from about 10 to 100 wt %, most preferably from about 30 to 100 wt % or from about 50 to 100 wt % of the total amount of solid particles.

The total content of particles in the second aqueous composition is preferably from about 1 to about 80 wt %, most preferably from about 5 to about 70 wt %, particularly most preferably from about 10 to about 60 wt % or from about 20 or even from about 25 to about 60 wt %.

The second aqueous composition may also comprise other additives commonly used for paper coating such as fluorescent whitening agents, colouring dyes, insolubilisers, lubricants, microbiocides, stabilisers, sizing agents, anti-foamers, etc, as well as various impurities from the raw materials. The total amount of other additives and possible impurities is preferably from 0 to about 50 wt %, most preferably from 0 to about 30 wt %, based on the dry content. The total dry content of the pigment composition is preferably from about 2 to about 80 wt %, most preferably from about 10 to about 75 wt % or from about 20 or even 30 to about 75 wt %.

It has been found that as the second aqueous composition, a composition comprising particles of colloidal primary silica or silicate based particles or aggregates thereof, with a low surface area, preferably below 450 m²/g, and prepared from alkali metal silicate by ion exchange as earlier described, is preferred.

The second aqueous composition is typically prepared by mixing the polyalkylene glycol and an aqueous composition comprising colloidal silica or silicate based particles. The polyalkylene glycol is preferably added to an aqueous dispersion of cationic colloidal silica or silicate based particles, for example by dissolving a solid powder into the aqueous dispersion, but may also be diluted or dissolved into e.g. water beforehand. A composition comprising a water soluble aluminium salt and/or a cationic organic polymer is preferably obtained by mixing these components with an aqueous dispersion, e.g. a sol, of colloidal silica or silicate based particles optionally also comprising other pigment particles as described herein and then adding polyalkylene glycol. Colloidal silica or silicate particles, water soluble aluminium salt and cationic polymer are preferably mixed in a way so substantial gelling or precipitation is avoided. For example, the aluminium salt and the cationic polymer may be mixed to form an aqueous solution thereof, and then an aqueous dispersion of colloidal and optionally other pigment particles can be added thereto, preferably under agitation to ensure that there always is a cationic net-charge of the particles in the resulting dispersion. Various suitable ways of mixing colloidal silica or silicate based particles and optionally other pigment particles with aluminium salts and cationic polymers are also described in the earlier mentioned WO 2006/049546 and WO 2006/049547.

The second aqueous composition is preferably applied in an amount sufficient to yield a second coating layer with a dry composition weight of from about 0.4 to about 40 g/m², more preferably from about 0.5 to about 40 g/m², most preferably from about 1 to about 25 g/m² per coated side of the substrate.

Methods of applying the first and second aqueous compositions on the substrate to form coating layers include, but are not limited to, blade coating, air knife coating, roll coating, curtain coating, spray coating, press size coating and cast coating. In case of metering film press coating, various rods and rod pressures could be used, for example from about 0.5 to about 8 bar, such as from about 1 to about 5 bar.

When coating paper or paper board, the coating may be performed in the paper or paper board machine or off the paper or paper board machine.

After applying the coatings, the coated substrate is dried, which in the case of on machine coating preferably is accomplished in a drying section of the machine. Any means of drying may be used, such as infra red radiation, hot air, heated cylinders or any combination thereof. The paper may then undergo any kind of conventional treatment such as calendering and the like. Various calendering pressures (line loads) can be used to achieve a desirable surface smoothness, for example from about 20 kN/m or lower up to about 700 kN/m or higher, or from about 50 or from about 100 to about 600 kN/m.

Preferably, an intermediate step of drying and optionally also a step of calendering is performed on the substrate after being coated by with the first composition, and before coating the substrate with the second compositions.

The term coating as used herein refers to any method in which pigments are applied to the surface of the substrate, thus including not only conventional coating but also other methods such as for example pigmenting.

An aspect of the invention relates to a kit of parts comprising a first aqueous composition as described herein and a second aqueous composition as described herein, intended to be used for coating a substrate such as a base paper, as described herein.

Another aspect of the invention relates to a coated substrate, especially a coated paper or paper board, obtainable by the method described above. A coated substrate, especially a coated paper or paper board, of the present invention comprises a substrate which on at least one side is provided with a first coating layer of the first aqueous composition as described above, and a second coating layer of a second aqueous composition, as described above, arranged on top of the first coating layer. The first and the second aqueous compositions are at least partially dried after application thereof. Regarding further details and embodiments of the first and second compositions, the above description of the same is referred to.

A coated paper of the invention preferably has a gloss value of above 60% at 75° as measured by the BYK Gardner method.

The invention will now be further described in following examples. Unless otherwise stated all parts and percentages refer to parts and percent by weight. Contents expressed as pph relate to parts per hundred parts of dry pigment particles.

### Example 1

In these tests, coated papers were produced containing two coating layers. For that purpose various formulations were prepared and applied on a base paper (80 g/m² copy paper from Staples Inc.).

### a) Preparation of Formulations for First Coating Layer.

Six formulations were prepared with different inorganic pigment compositions. The pigments were dispersed in water under stirring (10 000 rpm). A binder, styrene butadiene latex (Litex P6115 from Eka Polymer Latex Oy) was added followed by addition of CMC (Finnfix 10 from Noviant Oy). The formulations were adjusted to pH of between 8.5 and 9.5 (2 M NaOH) and were then kept under gentle stirring for two hours before use. The added amount of latex was the same in all formulations, 15 pph, that is 15 parts of dry latex on 100 parts of dry pigment. The amount of CMC was varied between 3 and 6 pph in order to get a viscosity around 500 cP (Brookfield viscosity meter, 25° C., no 4 spindle at 50 rpm). The formulations were calculated to give the same solids content in all six formulations (33 weight-%). In the following table formulations are given in more detail.

TABLE 1

| | | Amount | | | Surface * | Pore |
|---|---|---|---|---|---|---|
| | | (as is), | Solids | | Area, | Volume * |
| | Components | g | % | pph | g/m² | cm³/g |
| Pre 1 | Precipitated | 230 | 87 | 100 | 129 | 0.3139 |
| | silica ¹ | | | | | |
| | Water | 430 | — | — | | |
| | Latex | 60 | 50 | 15 | | |
| | CMC | 6 | 100 | 3 | | |
| Pre 2 | Clay ² | 212 | 94 | 100 | 9 | 0.0826 |
| | Water | 448 | — | — | | |
| | Latex | 60 | 50 | 15 | | |
| | CMC | 10 | 100 | 5 | | |
| Pre 3 | Silica Gel ³ | 100 | 100 | 100 | 351 | 1.0828 |
| | Water | 265 | — | — | | |
| | Latex | 30 | 50 | 15 | | |
| | CMC | 3 | 100 | 3 | | |
| Pre 4 | Calcium | 134 | 75 | 100 | 7 | 0.0761 |
| | carbonate ⁴ | | | | | |
| | Water | 196 | — | — | | |
| | Latex | 30 | 50 | 15 | | |
| | CMC | 5 | 100 | 5 | | |
| Pre 5 | Precipitated | 32 | 87 | 50 | 129 | 0.3139 |
| | silica ¹ | | | | | |
| | Clay ² | 30 | 94 | 50 | 9 | 0.0826 |
| | Water | 121 | — | — | | |
| | Latex | 17 | 50 | 15 | | |
| | CMC | 2 | 100 | 3.5 | | |
| Pre 6 | Precipitated | 16 | 87 | 25 | 129 | 0.3139 |
| | silica ¹ | | | | | |
| | Clay ² | 45 | 94 | 75 | 9 | 0.0826 |
| | Water | 122 | — | — | | |
| | Latex | 17 | 50 | 15 | | |
| | CMC | 2 | 100 | 4 | | |

¹ Zeolex 123 from Huber Inc.
² Capim NP from Imerys Minerals.
³ Sylojet P 612 from Grace Davison
⁴ Hydrocarb 60 from Omya.
* Surface area and pore volume of the pigment measured as N₂-adsorption (BET).

### b) Preparation of Formulations for Second Coating Layer.

A slurry with a dry content of 44 weight-% was prepared. The particle blend was a mixture of a silica sol, Bindzil 50/80 from Eka Chemicals and a clay, Capim NP from Imerys Minerals. The dry weight ratio between silica sol and clay was 75/25 in the dispersion. Bindzil 50/80 has a surface area of about 80 m²/g. In order to cationise the silica particles in the sol, 8.3 pph of polyaluminium chloride, (Locron L from Clariant) and 5.0 pph polyDADMAC (Polyquat 40 U 05 NV from Katpol) were mixed in an Ultra-turrax together with the particle blend. These additions of polyaluminium (expressed as Al₂O₃) and polyDADMAC, respectively, are calculated as parts of dry product on 100 parts of dry particles (pph). This slurry is hereinafter called Slurry A.

Four formulations were prepared by mixing water and different polyethylene glycol/oxide (PEG) products into slurry A under fairly gentle mixing (magnetic stirrer). The water addition was adjusted to give a solids concentration of 41 weight-% in all formulations. The amount of PEG was 25 dry parts to 100 parts of dry particles. The viscosity of the final formulations were between 500 and 1500 cP (Brookfield viscosity meter, 25° C., spindle no 3, 50 rpm). In table 2 the recipes of the formulations are given in detail.

TABLE 2

| | | Amount, g | | |
|---|---|---|---|---|
| | Components | (as is) | Dry content, % | pph |
| Top 1 | Slurry A | 200 | 44 | 100 |
| | Water | 45 | — | — |
| | PEG 1^{a} | 20 | 100 | 25 |
| Top 2 | Slurry A | 200 | 44 | 100 |
| | Water | 45 | — | — |
| | PEG 2^{b} | 20 | 100 | 25 |
| Top 3 | Slurry A | 200 | 44 | 100 |
| | Water | 45 | — | — |
| | PEG 3^{c} | 20 | 100 | 25 |
| Top 4 | Slurry A | 200 | 44 | 100 |
| | Water | 45 | — | — |
| | PEG 4^{d} | 20 | 100 | 25 |

^{a}Polyethylene glycol 20 000 from Fluka (Weight average molecular weight 20 kD).
^{b}Polyethylene glycol 35 000 from Fluka (Weight average molecular weight 35 kD).
^{c}Polyethylene oxide from Sigma-Aldrich (Weight average molecular weight 100 kD)
^{d}Polyethylene oxide from Sigma-Aldrich (Weight average molecular weight 200 kD)

### c) Coating Applications, Paper and Print Tests

The coating formulations were applied on one side of the paper by a draw down method. This method implies that the applicator is a wired rod and this is commonly used in laboratory coating tests. The formulations from table 1 were first applied on the paper surface as a first coating layer and the paper was then dried on a glossy drying drum at 80° C. The dried coat weight of the first coating layers were between 16 and 24 g/m². Formulations as given in table 2 were then applied as second coating layers on top of the first coating layers and the papers were once again dried on the drum. The weights of the second coating layers were between 7-13 g/m².

The double coated papers were calendered in a laboratory calender (from DT Paper Science, Finland). The calendering was performed at 22° C. and the papers passed the calender three times at a line load of 35 kN/m thereafter the line load was increased to 130 kN/m followed by passing the paper ten times at this line load. The papers were kept at 23° C. and 50% RH before testing of various properties. In the following, descriptions are given for the test methods used.

Before printing the papers, the gloss of the papers was measured. The measurements were done at 75° angle with a micro-gloss meter from BYK-Gardner Gmbh. Two inkjet printers were used to print the various papers, HP 6980 (from Hewlett Packard) and Canon iP4500 (from Canon). These two printers utilize dye based inks. The print picture consisted of seven colour blocks, cyan, magenta, yellow, green, blue and black. Various properties of the printing were tested.

Colour Gamut volume. The printed blocs and the unprinted paper were measured with a spectrophotometer (Colour Touch 2 from Technidyne) and the colour gamut volume was calculated. The gamut volume is approximated with a dodecahedral in the CEI L*a*b* colour space and the measurements of the colours give the corners in the dodecahedral (see “Rydefalk Staffan, Wedin Michael; Literature review on the colour Gamut in the Printing Process-Fundamentals, PTF-report no 32, May 1997”).

Ink drying time. These tests were performed on the black print since this ink was the slowest drying ink for the two printers. The test was done by gently weeping a tissue paper on the black printed area and this was done at various times (seconds) after the paper had been printed. The ink was regarded as dry when no blackening occurred on the tissue paper.

Ink rub off. Tests were performed 24 hours after the papers had been printed. In this case a tissue paper was rubbed over the black area and a visual judgment was done on how much blackening of the tissue paper occurred (good=no blackening, fair=slight blackening and poor=severe blackening on the tissue paper).

In tables 3 (printer HP 6980) and 4 (printer Canon iP4500) the results of all testing are given for various combination of first and second coating layers.

TABLE 3
Printer HP 6980

| | Pre-coat | Top-coat | Paper | Ink drying | Ink | Colour |
|---|---|---|---|---|---|---|
| | weight | weight | gloss | time | rub | gamut |
| | (g/m²⁾ | (g/m²⁾ | (%) | (sec.) | off | volume |
| Pre 1 + Top 4 | 24 | 8 | 82 | 10 | Good | 301293 |
| Pre 2 + Top 4 | 17 | 7 | 81 | 105 | Good | 287762 |
| (Reference) | | | | | | |
| Pre 3 + Top 4 | 19 | 13 | 67 | 0 | Good | 285030 |
| Pre 4 + Top 4 | 16 | 8 | 72 | 120 | Good | 294399 |
| (Reference) | | | | | | |
| Pre 5 + Top 4 | 18 | 8 | 80 | 45 | Good | 293716 |
| Pre 6 + Top 4 | 18 | 8 | 78 | 75 | Good | 283039 |
| (Reference) | | | | | | |
| Pre 1 + Top 1 | 24 | 8 | 83 | 20 | Poor | 306047 |
| Pre 1 + Top 2 | 24 | 8 | 83 | 20 | Poor | 302922 |
| Pre 1 + Top 3 | 24 | 9 | 83 | 20 | Fair | 308405 |

TABLE 4
Canon iP Printer

| | Pre-coat | Top-coat | Paper | Ink drying | Ink | Colour |
|---|---|---|---|---|---|---|
| | weight | weight | gloss | time | rub | gamut |
| | (g/m²⁾ | (g/m²⁾ | (%) | (sec.) | off | volume |
| Pre 1 + Top 4 | 24 | 8 | 82 | 5 | Good | 233499 |
| Pre 2 + Top 4 | 17 | 7 | 81 | >120 | Good | 246345 |
| (Reference) | | | | | | |
| Pre 3 + Top 4 | 19 | 13 | 67 | 15 | Good | 227414 |
| Pre 4 + Top 4 | 16 | 8 | 72 | 110 | Good | 262370 |
| (Reference) | | | | | | |
| Pre 5 + Top 4 | 18 | 8 | 80 | 30 | Good | 256363 |
| Pre 6 + Top 4 | 18 | 8 | 78 | 110 | Good | 249312 |
| (Reference) | | | | | | |
| Pre 1 + Top 1 | 24 | 8 | 83 | 10 | Poor | 243588 |
| Pre 1 + Top 2 | 24 | 8 | 83 | 0 | Fair | 249208 |
| Pre 1 + Top 3 | 24 | 9 | 83 | 15 | Fair | 252280 |

The results showed that high print quality (colour gamut volume), glossy papers were obtained for all combinations. However, the ink drying is much depending on the nature of the first coating layer. Those papers with first coating layers containing a fair amount of a porous, high surface area pigment such as precipitated or gelled silica, Pre 1, Pre 3 and Pre 5 gave a much faster ink drying than papers with the other first coating layers. It could also be seen that ink rub off tendency was lower when high molecular PEG is present in the second coating layer.

### Example 2

In this example two different formulations for the second coating layer were prepared for coating tests on plain copy paper (Staples Inc.) and copy paper coated with formulation Pre 1 (see table 1 in previous example 1) as a first coating layer. The first coating layer was applied as in example 1 and the coat weight in this case was 8.5 g/m².

In the preparation of the formulations for the second coating layer, 17.6 g polyaluminum chloride, (Locron L from Clariant, 40% expressed as dry Al₂O₃), 10.6 g polyDADMAC (Polyquat 40 U 05 NV from Katpol, 40 weight-% solution) and 22 g water were mixed and subjected to high shear in an Ultra Turrax mixer (10 000 rpm). To this solution, 242 g Bindzil 50/80 from Eka Chemicals (50 wt %) was slowly added under continuous high shear mixing. The resulting pigment slurry, hereinafter called Formulation B, had a dry content of 45.5%.

A second formulation for the second coating, formulation C, was prepared by mixing 15.5 g PEG (Polyethylene oxide from Sigma-Aldrich with molecular weight 200 kD) and 15 g water into 150 g of formulation B under magnetic stirring. This gave 25 parts PEG on 100 parts silica sol pigment. The dry content in this formulation was 46.4 wt-%. Three experiments were conducted with the two formulations, B and C;
1. Coating with formulation B on paper coated with Pre 1.
2. Coating with formulation C on paper coated with Pre 1.
3. Coating with formulation C on plain copy paper.

The application of the first coating layer and calendering of the papers were done as in example 1. Paper HP 6980 from gloss and printing were performed as in example 1. The papers were inkjet printed on Hewlett Packard. Colour gamut volume, ink drying time and ink rub off were evaluated as described in earlier example. In table 5 the results of these testing are shown.

TABLE 5

| | 1st coat | 2nd coat | | | | |
|---|---|---|---|---|---|---|
| | layer | layer | Paper | | Ink | Colour |
| | weight, | weight, | Gloss, | Ink drying | rub | gamut |
| Experiment | g/m² | g/m² | % | time, sec. | off | volume |
| 1 (Refer- | 8.5 | 14.9 | 55 | 60 | Poor | 305349 |
| ence) | | | | | | |
| 2 | 8.5 | 12.4 | 68 | 15 | Good | 317938 |
| 3 (Refer- | 0 | 13.2 | 49 | 90 | Good | 307186 |
| ence) | | | | | | |

These results show high quality printouts with respect to colour gamut volume. However the highest gloss and fastest ink drying are obtained for the paper with the combination of a first coating layer containing the porous high surface area pigment such as precipitated silica and a silica sol based second coating layer containing PEG (concept 2 in the table).

### Example 3

In these experiment a cationic silica sol, Bindzil CAT 220 from Eka Chemicals was used. This product contained 30 weight-% solids and had a surface area of 220 m²/g. Two formulations for the second coating layer were prepared based on this silica sol. One (D) containing 5 pph PEG and another (E) with 15 pph PEG (dry parts on 100 parts dry Bindzil). PEG was, in this case, a polyethylene oxide product with molecular weight of 100 kD (Sigma-Aldrich). Papers with coated with Pre 1 (see table 1 in example 1) a the first coating layer were laboratory coated with the two formulations D and E (31% solids). As a reference, one set of paper coated with Pre 1 was also coated with the sole Bindzil product (PEG free). The papers were calendered, printed and tested as described in example 1. In addition print gloss was measured with a Micro-Gloss meter from BYK Gardner. One measurement was done on each printed colour block and the average result was calculated. Two printers were used in these tests, HP D5460 and HP 8250, the former one has pigmented inks whilst the latter one utilizes dye based inks. In tables 6 and 7 the results of all testing are given for the two printers respectively.

TABLE 6
HP D5460

| | 1^{st} coat | 2^{nd} coat | | | Ink | | |
|---|---|---|---|---|---|---|---|
| 2^{nd} | layer | layer | Paper | Print | drying | Ink | Colour |
| coating | weight, | weight, | Gloss, | Gloss, | time, | rub | gamut |
| layer | g/m² | g/m² | % | % | sec. | off | volume |
| Refer- | 8.9 | 8.8 | 51 | 41 | 60 | Fair | 241966 |
| ence | | | | | | | |
| D | 8.9 | 7.3 | 61 | 53 | 30 | Fair | 257736 |
| E | 8.9 | 9.2 | 69 | 61 | 30 | Fair | 267454 |

TABLE 7
HP 8250

| | 1^{st} coat | 2^{nd} coat | | | Ink | | |
|---|---|---|---|---|---|---|---|
| 2^{nd} | layer | layer | Paper | Print | drying | Ink | Colour |
| coating | weight, | weight, | Gloss, | Gloss, | time, | rub | gamut |
| layer | g/m² | g/m² | % | % | sec. | off | volume |
| Refer- | 8.9 | 8.8 | 51 | 38 | 0 | Fair | 275351 |
| ence | | | | | | | |
| D | 8.9 | 9.2 | 61 | 42 | 0 | Fair | 261278 |
| E | 8.9 | 7.3 | 69 | 59 | 0 | Good | 267454 |

The print quality in terms of colour gamut is good for all two layered samples, that is approximately 60% higher colour gamut compared to what is obtained for a plain uncoated copy paper. Furthermore, the ink drying rate is increased for the printer with pigmented ink (HP D5460) when the top-coating contained PEG (concept D and E in the example). For the other printer (HP 8250), the inks dried instantly independently of the PEG content in the second coating layer, that means that the nature of the second coating layer is less critical in this case.

Paper gloss as well as the print gloss of printouts from both of the printers, are significantly higher for concept D and E compared to reference.

1. A method for the preparation of a coated substrate, comprising the steps of:
a) providing a substrate;
b) applying on at least one side of said substrate a first coating layer of a first aqueous composition comprising porous anionic pigment particles having a BET surface area of above 40 m²/g and a binder; and
c) applying on said first coating layer a second coating layer of a second aqueous composition comprising cationic colloidal silica or silicate based particles and polyalkylene glycol.

2. The method according to claim 1, wherein said substrate is paper or paperboard.

3. The method according to claim 1, wherein said first aqueous composition comprises, as pigment particles, precipitated, fumed or gel-type silica particles.

4. The method according to claim 3, wherein said precipitated, fumed or gelled silica particles constitutes from 50 to 100 wt % of the dry pigment particles in said first composition.

5. The method according to claim 1, wherein said first aqueous composition is applied on said substrate at a dry composition weight of at least 1 g/m².

6. The method according to claim 1, wherein said cationic colloidal silica or silicate based particles in said second aqueous composition have a BET surface area of from about 30 to about 600 m²/g.

7. The method according to claim 1, wherein said cationic colloidal silica or silicate based particles in said second aqueous composition originates from a sol of colloidal silica or silicate based particles.

8. The method according to claim 1, wherein said cationic colloidal silica or silicate based particles comprises colloidal silica or silica based particles and a cationic component selected from the group consisting of water soluble aluminium salts, cationic polymers and mixtures thereof.

9. The method according to claim 1, wherein said colloidal silica or silicate based particles in said second aqueous composition have a mean diameter of from about 5 to about 125 nm.

10. The method according to claim 1, wherein said polyalkylene glycol has a weight average molecular weight of from 10,000 to 500,000 D.

11. The method according to claim 1, wherein said polyalkylene glycol comprises polyethylene glycol.

12. The method according to claim 1, wherein said polyalkylene glycol is present in said second composition at a concentration by weight of at least 2 pph based on 100 parts of said colloidal silica or silicate based particles.

13. The method according to claim 1, wherein said second aqueous composition is applied on said first coating layer at a dry composition weight of at least 1 g/m².

14. A coated substrate, comprising a substrate having at least one side coated with a first coating layer and a second coating layer on top of said first coating layer, wherein
said first coating layer has been obtained by drying a first aqueous composition comprising anionic porous pigment particles having a BET surface area of above 40 m²/g and a binder, and
said second coating layer has been obtained by drying a second aqueous composition comprising cationic colloidal silica or silicate based particles and polyalkylene glycol.

15. Kit of parts including a first aqueous composition comprising anionic porous pigment particles having a BET surface area of above 40 m²/g and a binder; and a second aqueous composition comprising cationic colloidal silica or silicate based particles and polyalkylene glycol.

16. The method according to claim 2, wherein said first aqueous composition comprises, as pigment particles, precipitated, fumed or gel-type silica particles, and wherein said precipitated, fumed or gelled silica particles constitutes from 50 to 100 wt % of the dry pigment particles in said first composition.

17. The method according to claim 1, wherein the total content of pigment particles in the first aqueous composition is from about 1 to about 70 wt % of the total composition.

18. The method according to claim 1, wherein the dry content of the cationic silica or silicate bases particles in the second aqueous composition is from about 0.5 to about 70 wt %.
